(19) United States
(12) Patent Application Publication
(10) Pub. No.: US 2022/0120443 A1
(43) Pub. Date: Apr. 21, 2022

(54) COMBINATION COOKTOP AND MICROWAVE

(71) Applicant: Way Interglobal Network, LLC, Elkhart, IN (US)

(72) Inventor: Chris Greer, Syracuse, IN (US)

(73) Assignee: Way Interglobal Network, LLC, Elkhart, IN (US)

(21) Appl. No.: 17/076,016

(22) Filed: Oct. 21, 2020

(51) Int. Cl. F24C 7/02; F24C 3/02; F24C 3/08

(52) U.S. Cl. CPC F24C 7/02; F24C 3/122; F24C 3/082; F24C 3/022

(57) ABSTRACT

A combination microwave and cooktop has a transparent lid that is movable between a closed position where the lid overlays burners and an open position that exposes the burners. The microwave is located inside an enclosure that affixes the microwave through apertures in a bottom wall of the enclosure. A front trim bezel surrounds the front of the microwave and is affixed to the enclosure. Airflow for ventilation around the microwave is accomplished through vents in the rear wall of the enclosure and apertures in a top portion of the front trim bezel.

### BACKGROUND OF THE INVENTION

This present disclosure relates to built-in cooking appliances. In campers, trailers, or other recreational vehicles (RVs), space is a premium. Consumers want the cooking options that are available in their house without consuming the large space these appliances typically require. A microwave oven is a staple appliance in an RV, along with a refrigerator and gas cooktop. Some microwave ovens have a convection oven feature, meaning the microwave also has an electric heating element, allowing the user to cook with microwave energy, heating elements, or a combination of both. The cooktop is typically mounted into a cutout in the countertop and the microwave is mounted nearby but still separate. This requires additional wiring and cabinet modifications to install both devices. Further, built-in microwaves can suffer from overheating, shortening the life of the electronic components, and posing a safety risk. An improved device is needed.

### SUMMARY OF THE INVENTION

The present disclosure describes a combination gas cooktop and microwave in a single device. The gas cooktop is affixed to an enclosure that receives the microwave. The combination cooktop and microwave can mount in a similar or same cabinet and countertop cutout as an existing oven and cooktop, simplifying RV design and allowing standardizing of interior components. The cooktop is part of an enclosure that has a cavity to retain the microwave. The cavity allows airflow around the microwave to keep electronic components cool and providing insulation from surrounding cabinet materials.

### BRIEF DESCRIPTION OF THE DRAWINGS

FIG. 1 is a front isometric view of the cooktop and microwave;

FIG. 2 is a rear isometric view of the cooktop and microwave;

FIG. 3 is an exploded isometric view of the cooktop and microwave;

FIG. 4 is a section view 4-4 of the cooktop and microwave as shown in FIG. 3;

FIG. 5 is a section view 5-5 of the cooktop and microwave as shown in FIG. 1; and

FIG. 6 is rear exploded isometric view of the cooktop and microwave.

### DESCRIPTION OF THE PREFERRED EMBODIMENT

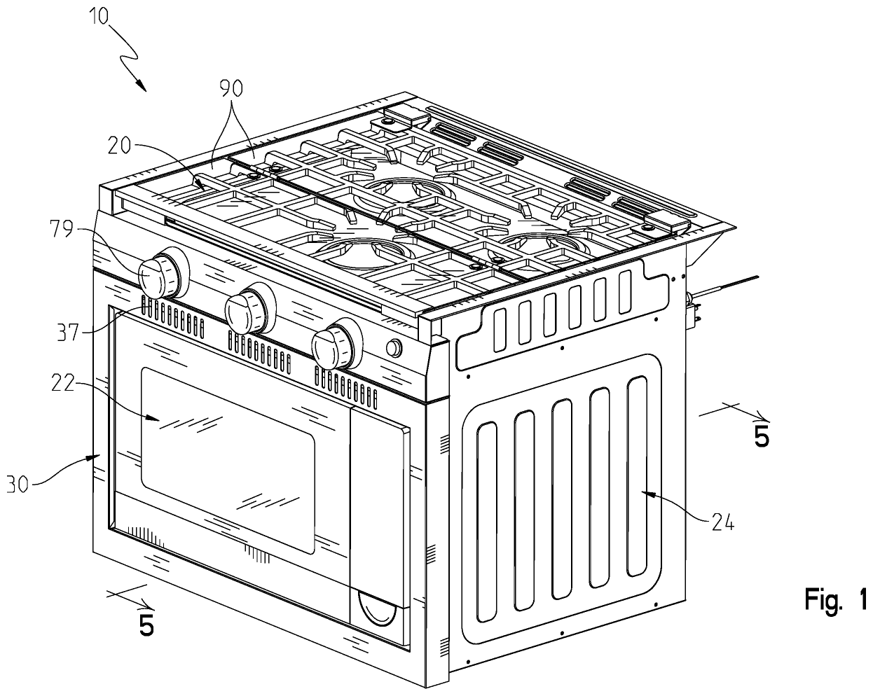

A combination cooktop and microwave cooking appliance 10 is shown in FIG. 1 and has a cooktop 20 and a microwave 22. The cooktop 20 is affixed to a shell 24. The microwave 22 is affixed inside a cavity 26 of the shell 24 but is removable for service or replacement. A removable front cover 30 provides ventilation to the microwave 22 and provides a decorative bezel to obscure the cavity 26. The appliance 10 is designed to be installed in a cabinet that has a corresponding cutout in the countertop (not shown).

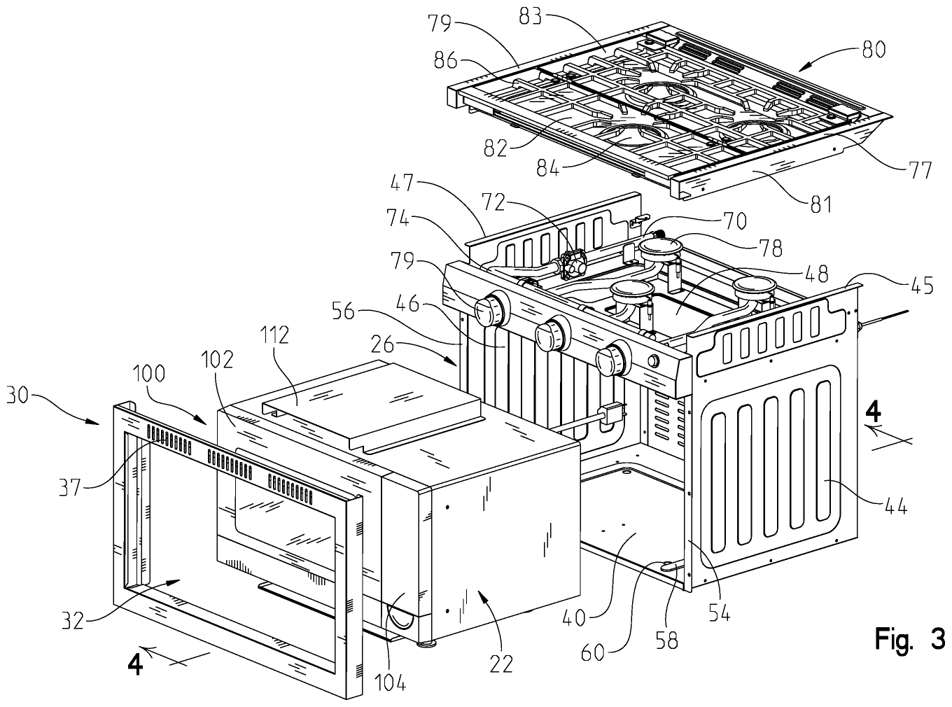

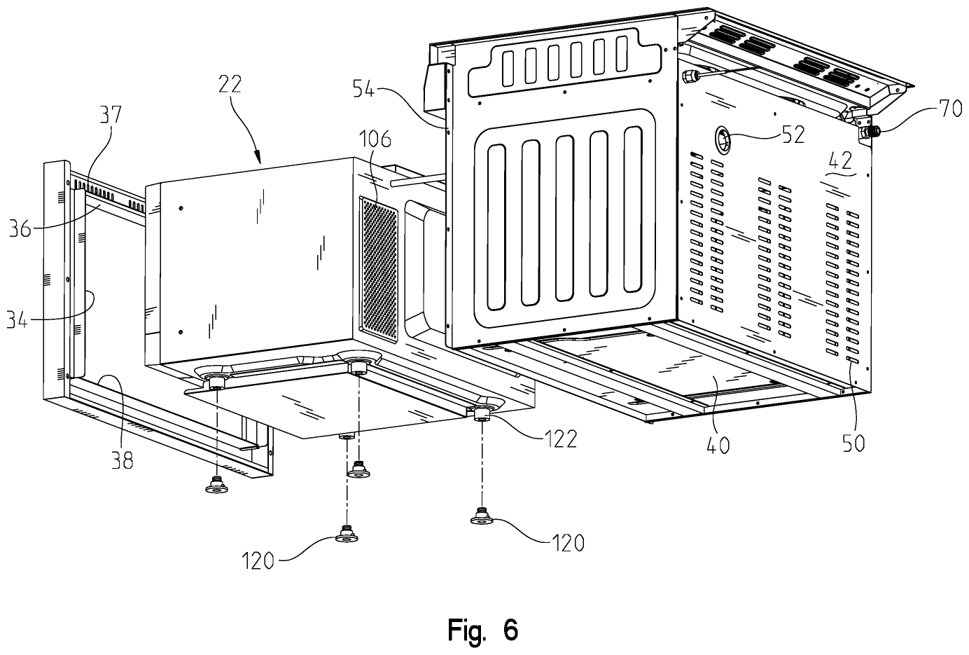

The shell 24 has a bottom wall 40, a back wall 42, and side walls 44, 46. As installed, the side walls 44, 46, back wall 42, and bottom wall 40 are hidden from the user. The back wall 42 includes ventilation apertures 50 and cord access 52 into the cavity 26. The bottom wall 40 includes a guide ridge 58 that partially surrounds anchoring apertures 60 on three sides. The guide ridge 58 is a raised surface above the surface of the bottom wall 40. The anchoring apertures 60 are holes through the bottom wall 40 that are positioned to correspond to mounting points on the microwave 22. The side walls 44, 46 are affixed to the bottom wall 40 and back wall 42. A top wall 48 is spaced from and substantially parallel to the bottom wall 40. The bottom wall 40 is substantially parallel to the top wall 48, but individual elevation differences, such as the guide ridge 58 prevent perfect geometric parallelism to the top wall 48. The side walls 44, 46, bottom wall, 40, top wall 48, and back wall 42 cooperate to form the cavity 26. As shown, the side walls 44, 46 extend beyond the top wall 48 and terminate at top flanges 45, 47. This is shown in FIG. 3. The top wall 48 is a border between the cavity 26 and the cooktop 20. As can be seen in FIG. 6, the back wall 42 stops just above the top wall 48. The gap at the top of the back wall 42 provides fresh air to supply the cooktop 20.

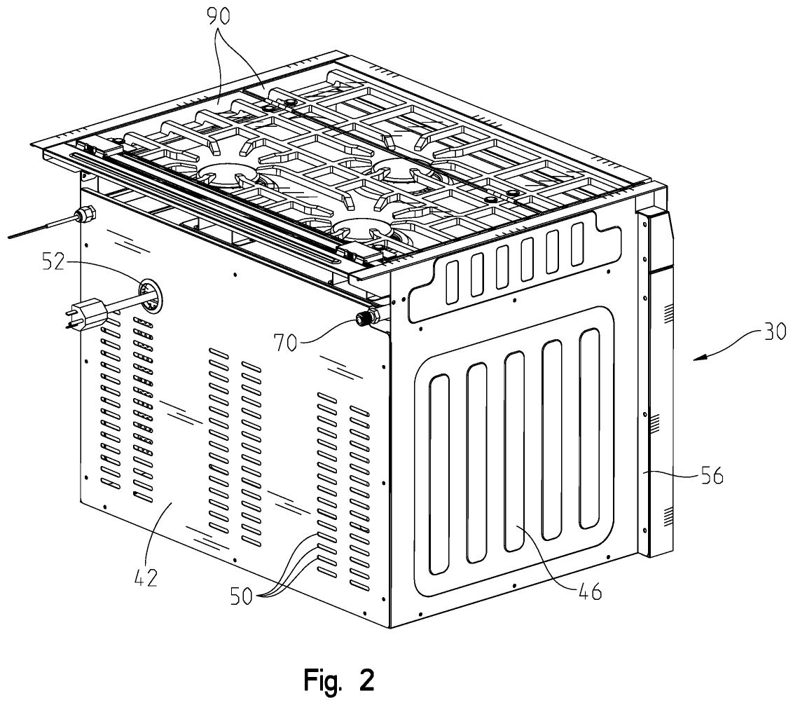

As shown, the cooktop 20 is powered by natural gas, propane, or other combustible fuel. A gas supply 70 is where the appliance 10 is connected to the external fuel source (not shown). The supply 70 feeds a regulator 72 which feeds a manifold 74 and valves 76. For each valve 76, there is a burner 78 that is affixed to the top wall 48. In the embodiment shown herein, there are three valves 76 and burners 78, but a different number of is contemplated. Knobs 79 control each valve 76 for the user to adjust the flame for each burner 78. A cover 80 overlays the top wall 48 and is removable. The cover 80 has lateral sides 81, 83 that are separated by a drip pan 82. The drip pan 82 has burner apertures 84 and a removable grate 86 to give clear access to the burners 78 and drip pan 82. The cover 80 includes a hinged glass lid 90 that is movable between an opened and closed position. The lid 90 is hinged between the lateral sides 81, 83 of the cover 80 and the lid folds so the front portion overlays the rear portion. The rear portion of the lid 90 is hinged with respect to the cooktop 20 for access to the rear burners. In FIG. 2, the lid 90 is shown in the closed position where it overlays the grate 86 and burners 78. In the closed position, the lid 90 is located between the lateral sides 81, 83 of the cover 80. In the opened position, the lid 90 is located outside of the cover and not between the lateral sides 81, 83 where the burners 78 are exposed and can be used for cooking. The side walls 44, 46 support the cooktop 20, in particular, the cover 80, grate 86, drip pan 82, and related components. The cover 80 has flanges 77, 79 that extend outwardly to overlie the top flanges 45, 47. This supports the cover 80 above the top wall 48. The top wall 48 supports the burners 78, supply 70, regulator 72, manifold 74, valves 76, and related components. This is visible in FIG. 3.

The removable front cover 30 is affixed to the shell 24 with fasteners are inserted through holes in front flanges 54, 56 in corresponding side walls 44, 46. The fasteners thread into threaded holes on the front cover 30. The front cover 30 includes a central cover opening 32 that includes side inset walls 34 and a top inset wall 36. A bottom wall 38 is located opposite of the top inset wall 36. The walls 34, 36, 38 surround the central cover opening and extend inwardly into the cavity 26. The inset walls 34, 36 include a step that is offset from the central cover opening 32. By being bent towards the opening 32, the step on the inset walls 34, 36 effectively narrows the central cover opening 32. The removable front cover 30 has a front surface 35 that includes an area with a vent 37. As shown, the front surface 35 is flat or planar. The vent 37 is a plurality of apertures through the front surface 35 to provide a path for heated air 116 to exit the cavity 26. The vent 37 is located just below the knobs 79 at a high point relative to the cavity 26. Because hot air rises, the location of the vent 37 prevents hot air from building up inside the cavity 26.

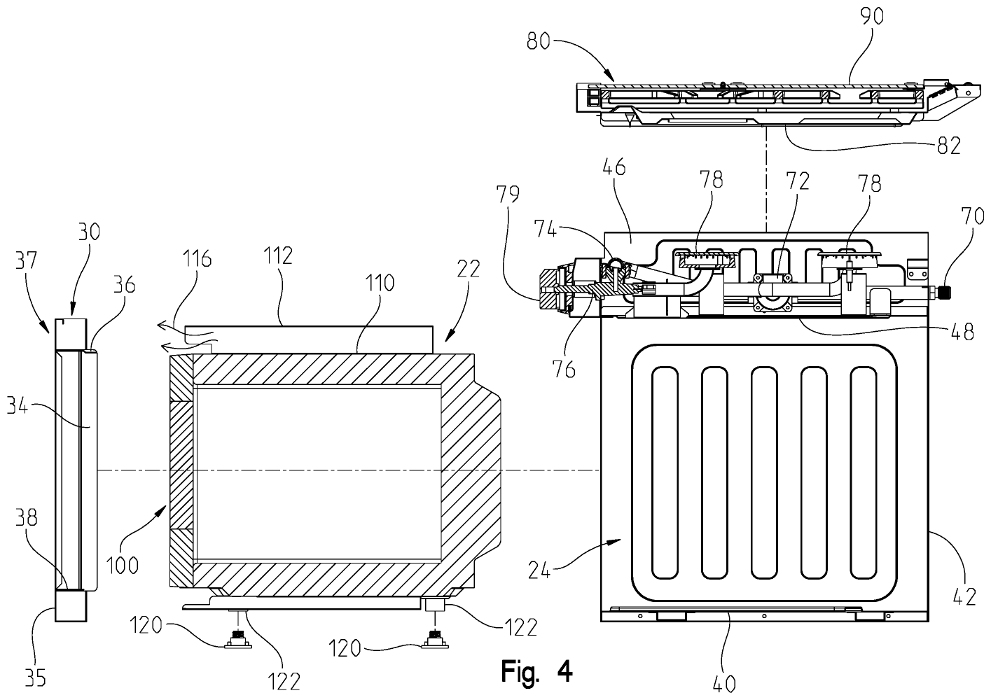

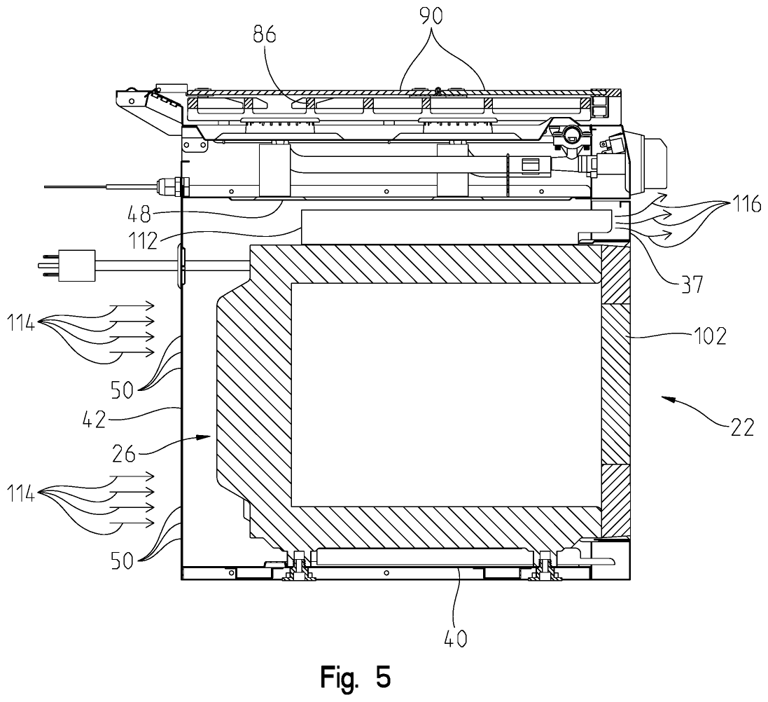

The microwave 22 is affixed and located inside the cavity 26 through the anchoring apertures 60. Fastening feet 120 thread into corresponding receivers 122 in the bottom through the anchoring apertures 60. Each receiver 122 has a recessed pocket that receives the respective fastening foot 120 to pinch the portion of the bottom wall 40 around the respective anchoring aperture 60. This affixes and locates the microwave 22 inside the cavity 26. The microwave 22 has a face 100 comprising a door 102 and a button panel 104. The face 100 extends to a microwave shell 28, which has roughly the same outside envelope. In other words, the face 100 has a perimeter profile that is aligned with the microwave shell 28. This is visible in FIG. 3. The door 102 and button panel 104 are the only portions of the microwave 22 that are visible to the user. The face 100 is sized to fit into the central cover opening 32 and be flush or otherwise aligned with the front surface 35 as installed. The microwave 22 has air inlets 106 for drawing in fresh air 114 and air outlets 110 for exhausting heated air 116. As is known in the art, microwaves need to draw in fresh air 114 to keep the internal electronics from overheating, along with exhausting heated air from the electronics along with heat and moisture from any cooking food. These sources of heat and moisture from the microwave 22 are combined and exhausted as heated air 116, shown in FIG. 5. The air outlet 110 is located on the top of the microwave 22 with an exhaust duct 112 that directs heated exhaust or heated air 116 toward the vent 37. This can be seen in FIGS. 4 and 5. The door 102 opens and closes in a conventional manner and would interfere with the side and inset walls 34, 36 but because of the offset step portion of the walls 34, 36, any contact made with the microwave 22 is on the microwave shell 28 and offset from the door 102. For example, the offset step portion of the top inset wall 36 can be seen contacting the microwave 22 on the microwave shell 28 and away from the door 102 in FIG. 5. This allows the microwave 22 to be closely fitted to the central cover opening 32, as shown in FIG. 1, without undesirable rubbing, scraping, or interference when the door 102 is opened and closed.

While not explicitly shown in the FIGS., the microwave 22 may include convection oven components. As is known in the art, a convection microwave oven can cook through conventional microwave energy or heating elements. The heating elements are commonly coupled with a fan or blower to circulate the heated air inside the cooking area of the microwave. Whether the microwave 22 includes convection oven components or is a conventional microwave, heated air 116 is exhausted from the microwave 22 during use.

To remove the microwave 22 from the appliance 10 for replacement, repair, or maintenance, the user first removes the appliance 10 from its mounting location (not shown). Next, the user removes the fasteners that retain the front cover 30 to the front flanges 54, 56. The fasteners for the front cover 30 are otherwise covered or hidden by the cabinetry in the mounting location for the appliance 10. The user unscrews the fastening feet 120 to detach the microwave 22 from the bottom wall 40. To install the microwave 22, the user places it inside the cavity 26 and extends the cord through the cord access 52. The user uses the guide ridge 58 to align with the receivers 122 to the anchoring apertures 60. The fastening feet 120 are installed into the receivers 122 through the anchoring apertures 60. This aligns the face 100 so that the removable cover 30 can be installed. The fasteners are installed to secure the front cover 30 to the front flanges 54, 56.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A combination cooktop and microwave comprising:
an enclosure having a cooktop affixed over a cavity, said cavity defined by a bottom wall spaced from a top wall, a back wall and side walls connecting said bottom wall to said top wall, said bottom wall having anchoring apertures, said top wall forming a boundary between said cavity and said cooktop, said side walls extending above said top wall and terminate at top flanges extending outwardly from said sidewalls, said cooktop having at least one burner controlled by a gas valve, said cooktop having a drip pan, said drip pan having at least one burner aperture to receive said burner, said cooktop having a hinged lid movable between an open state and a closed state, said closed state is defined by said hinged lid overlaying said burner and said grate, said open state is defined by said hinged lid clear of said burner, said side walls having front flanges;
a removable front cover having a planar surface surrounding a central cover opening, a portion of said planar surface having a vent, said front cover affixed to said enclosure at said front flanges, said removable front cover having a top inset wall and side inset walls, said top and side inset walls extending into said cavity around said central cover opening, said top and side inset walls each having an offset portion;
a microwave located in said cavity and having locating feet aligned to said anchoring apertures, said microwave having a front surface being substantially coplanar with said removable front cover;
fastening feet extending through anchoring apertures to said locating feet to affix said microwave to said enclosure; and
an airflow path extends from ventilation apertures in said back wall into said cavity to supply said cavity with fresh air, when said microwave exhausts heated air, said heated air exits said vent in said removable front cover.

2. The combination cooktop and microwave of claim 1, wherein said microwave includes convection oven components.

3. The combination cooktop and microwave of claim 1, further comprising an exhaust duct on said microwave, said exhaust duct having an opening that faces said vent in said removable front cover.

4. The combination cooktop and microwave of claim 1, wherein said microwave has a microwave shell, said microwave shell is spaced from said top, back, and side walls of said enclosure.

5. The combination cooktop and microwave of claim 4, wherein said offset portions of said top and side inset walls are in biased contact with said microwave shell.

6. The combination cooktop and microwave of claim 4, wherein said microwave has a face comprising a door and a button panel, said face is aligned with said microwave shell.

7. The combination cooktop and microwave of claim 1, wherein said drip pan is supported by said side walls, said burner is supported by said top wall.

8. A combination cooktop and microwave comprising:
an enclosure having a cooktop affixed over a cavity, said cavity defined by a bottom wall spaced from a top wall, a back wall and side walls connecting said bottom wall to said top wall, said bottom wall having anchoring apertures, said top wall forming a boundary between said cavity and said cooktop, said side walls extending above said top wall, said cooktop having at least one burner controlled by a gas valve, said cooktop having a drip pan, said drip pan having a burner aperture to receive said burner, a removable grate, said cooktop having a hinged lid movable between an open state and a closed state, said closed state defined by said hinged lid overlaying said burner and said grate, said open state defined by said hinged lid clear of said burner, said side walls having front flanges;
a removable front cover having a front surface surrounding a central cover opening, a portion of said front surface having a vent, said front cover affixed to said enclosure at said front flanges;
a microwave having locating feet aligned to said anchoring apertures, said microwave having a front surface located in said central cover opening and being substantially aligned with said front surface on said removable front cover;
fastening feet extending through said anchoring apertures to said locating feet to affix said microwave to said enclosure; and
an airflow path extends from ventilation apertures in said back wall into said cavity to supply said cavity with fresh air, when said microwave exhausts heated air, said heated air exits said vent in said removable front cover.

9. The combination cooktop and microwave of claim 8, wherein said microwave includes convection oven components.

10. The combination cooktop and microwave of claim 8, further comprising an exhaust duct on said microwave, said exhaust duct having an opening that faces said vent in said removable front cover.

11. The combination cooktop and microwave of claim 8, wherein said microwave has a microwave shell, said microwave shell is spaced from said top, back, and side walls when said microwave is affixed to said enclosure.

12. The combination cooktop and microwave of claim 11, wherein said removable front cover having a top inset wall and side inset walls, said top and side inset walls extending into said cavity around said central cover opening, said top and side inset walls each having an offset portion.

13. The combination cooktop and microwave of claim 12, wherein said offset portions of said top and side inset walls are in biased contact with said microwave shell.
